(19) United States
(12) Patent Application Publication
(10) Pub. No.: US 2006/0087531 A1
(43) Pub. Date: Apr. 27, 2006

(54) Inkjet printing apparatus

(76) Inventors: Michael J. Eiseman, Swarthmore, PA (US); Harry Joseph Spinelli, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/254,424

(22) Filed: Oct. 20, 2005

Related U.S. Application Data
(60) Provisional application No. 60/621,802, filed on Oct. 25, 2004.

(51) Int. Cl. B41J 2/21

(52) U.S. Cl. 347/43

(57) ABSTRACT

This invention pertains to an apparatus for reliable, high-speed inkjet printing and, in particular, to an apparatus with a fixed array inkjet printhead having redundant nozzle arrangements.

### CROSS-REFERENCE TO RELATED APPLICATIONS

This application claims priority under 35 U.S.C. §119 from U.S. Provisional Application Ser. No. 60/621,802 (filed Oct. 25, 2004), the disclosure of which is incorporated by reference herein for all purposes as if fully set forth.

### BACKGROUND OF THE INVENTION

This invention pertains to an apparatus for reliable, high-speed inkjet printing and, in particular, to an apparatus with a fixed array inkjet printhead.

Inkjet printing is a non-impact printing process in which droplets of ink are deposited on print media, such as paper, to form the desired image. The droplets are ejected from a printhead in response to digital signals generated by a microprocessor.

Inkjet printers offer low cost, high quality printing and have become a popular alternative to other types of printers. However, inkjet printers are presently unable to match the speed of these other printers, especially laser printers.

Most commercial inkjet printers operate with a scanning printhead that moves back and forth over the surface of the print medium printing swathes of the image. The print medium is then advanced step-wise in a direction perpendicular to the scanning direction and the next swath of the image is printed.

Full-width arrays (FWA) have been proposed as one means to increase throughput. In a full-width array, the printhead is at least as wide as the print medium so an image can be printed in a single pass with the substrate moving under the printhead in a direction perpendicular to the array. Historically full-width arrays have not been widely used because of high cost and difficulty of manufacture. However improvements in manufacturing processes and the development of new inkjet printhead technologies have now made FWA printheads commercially and technically viable.

Because of the large number of nozzles and inability to interlace drops to compensate for failed nozzles, the FWA printheads will need to be highly reliable.

U.S. Pat. No. 5,587,730 (the disclosure of which is incorporated by reference herein for all purposes as if fully set forth) discloses a full width array printer equipped with a secondary printhead that can be adapted to print in place of a failed primary printhead.

It is an objective of this invention to provide a fixed array inkjet printer with improved reliability.

### SUMMARY OF THE INVENTION

In accordance with one aspect of the present invention, there is provided an inkjet printing apparatus comprising:

(a) a plurality of ink supply paths, comprising a first ink supply path for connection to a first ink supply to contain a first ink of a first color, a second ink supply path for connection to a second ink supply to contain a second ink of a second color, a third ink supply path for connection to a third ink supply to contain a third ink of substantially the same color as said first color, and a fourth ink supply path for connection to a fourth ink supply to contain a fourth ink of substantially the same color as said second color, wherein said first and second colors are not substantially the same;

(b) an inkjet printhead array in fixed position, responsive to digital data signals and in connection with said plurality of ink supply paths such that, when an ink supply containing an ink is connected to an ink supply path, said ink can flow from said ink supply to said inkjet printhead array;

(c) a printing zone defined by said inkjet printhead array; and

(d) a means for moving a substrate to be printed past said printing zone;

wherein said inkjet printhead array comprises a plurality of series of nozzles, each of said series of nozzles being arranged in a direction generally across said printing zone, said plurality of series of nozzles comprising:

a first series of nozzles being in connection with said first ink supply path such that, when a first ink supply is connected to said first ink supply path, a first ink can flow from said first ink supply to said first series of nozzles;

a second series of nozzles being in connection with said second ink supply path such that, when a second ink supply is connected to said second ink supply path, a second ink can flow from said second ink supply to said second series of nozzles;

a third series of nozzles being in connection with said third ink supply path such that, when a third ink supply is connected to said third ink supply path, a third ink can flow from said third ink supply to said third series of nozzles; and

a fourth series of nozzles being in connection with said fourth ink supply path such that, when a fourth ink supply is connected to said fourth ink supply path, a fourth ink can flow from said fourth ink supply to said fourth series of nozzles;

said third series of nozzles being redundant to said first series of nozzles, and said fourth series of nozzles being redundant to said second series of nozzles.

Preferably, the inkjet printing apparatus further comprises:

(e) a first ink supply containing a first ink of a first color connected to said first ink supply path, such that said first ink can flow from said first ink supply to said first series of nozzles;

(f) a second ink supply containing a second ink of a second color connected to said second ink supply path, such that said second ink can flow from said second ink supply to said second series of nozzles;

(g) a third ink supply containing a third ink of substantially the same color as said first color connected to said third ink supply path, such that said third ink can flow from said third ink supply to said third series of nozzles; and

(h) a fourth ink supply containing a fourth ink of substantially the same color as said second color connected to said fourth ink supply path, such that said fourth ink can flow from said fourth ink supply to said fourth series of nozzles;

wherein said first and second colors are not substantially the same.

In the above embodiment, the first and third inks are of substantially the same first color, and the second and fourth inks are of substantially the same second color (but not substantially the same as the first color). Each ink in the pair may be the identical ink (e.g., first ink=third ink and second ink=fourth ink), in which case the color of both inks in the pair would be the same. Each ink in the pair may also be a different ink (different composition, e.g., first ink≠third ink and second ink≠fourth ink), but the intention is that the color of each of the inks in the pair should be close enough so that the redundant ink can be utilized in place of the primary ink without any significant visual change in the appearance of the resulting print. For example, one ink of a specified color may have a specific composition, and another ink of substantially that same color may be similar in composition but contain a variation on ingredients to optimize a performance aspect such as decap time.

When each ink in a pair of inks is the identical ink, the corresponding ink supplies may in fact be a single ink supply connected to the corresponding ink supply paths. In other words, in this embodiment of identical inks, a single ink supply may optionally be used to provide ink to both the primary and redundant set of nozzles. In the context of the above broad expression of the invention, in this embodiment the first and third inks supplies could in fact be one and the same, and the second and fourth inks supplies could also in fact be one and the same. This also applies to additional inks and ink supplies as discussed below.

In one preferred embodiment, all three primary colors are utilized—cyan (C), magenta (M) and yellow (Y). In another preferred embodiment, black (K) is also utilized with CMY.

When a third color is utilized, it is preferred, for each of the three colors of ink that there is:

at least one ink supply containing an ink of such color if the primary and redundant inks are the same, or at least two ink supplies if the primary and redundant inks are different;

at least two ink paths for each ink supply if the primary and redundant inks are the same and a single ink supply is used for both the primary and redundant inks, or at least at least one ink path for each ink supply otherwise; and

at least one series of nozzles for each ink path.

Stated another way, when a third color is utilized, the printing apparatus (plurality of ink supply paths) further comprises:

a fifth ink supply path for connection to a fifth ink supply to contain a fifth ink of said third color; and

a sixth ink supply path for connection to a sixth ink supply to contain a sixth ink of substantially the same color as said third color,

wherein said first, second and third colors are not substantially the same, and wherein the inkjet printhead array (plurality of series of nozzles) further comprises:

a fifth series of nozzles being in connection with said fifth ink supply path such that, when a fifth ink supply is connected to said fifth ink supply path, a fifth ink can flow from said fifth ink supply to said fifth series of nozzles; and

a sixth series of nozzles being in connection with said sixth ink supply path such that, when a sixth ink supply is connected to said sixth ink supply path, said sixth ink can flow from said sixth ink supply to said sixth series of nozzles;

with said sixth series of nozzles being redundant to said fifth series of nozzles.

In addition to the two colors in the broadest concept, other colors may be utilized associated with and without redundant series of nozzles. Stated another way, when another color is utilized (in this case referred to as the fourth color), the printing apparatus (plurality of ink supply paths) further comprises:

a seventh ink supply path for connection to a seventh ink supply to contain a seventh ink of said fourth color; and

optionally, an eighth ink supply path for connection to an eighth ink supply to contain an eighth ink of substantially the same color as said seventh color;

wherein said first, second, third (if present) and fourth colors are not substantially the same, and wherein the inkjet printhead array (plurality of series of nozzles) further comprises:

a seventh series of nozzles being in connection with said seventh ink supply path such that, when a seventh ink supply is connected to said seventh ink supply path, a seventh ink can flow from said seventh ink supply to said seventh series of nozzles; and

optionally, an eighth series of nozzles being in connection with said eighth ink supply path such that, when an eighth ink supply is connected to said eighth ink supply path, an eighth ink can flow from said eighth ink supply to said eighth series of nozzles;

with said eighth series of nozzles, when present, being redundant to said seventh series of nozzles.

In the above embodiment, when four colors are used such as CMYK, it is thus possible to have redundant series of nozzles for CMY but no single redundant series of nozzles for K. Since K (and other colors) can be formed from various combinations of CMY, it is thus possible for the CMY redundant nozzles in combination to function as the redundant nozzle for K (and other colors based on various combinations of CMY).

The inkjet printer can be operated in a variety of different modes to utilize the capabilities of the redundant nozzle sets. For example, when print quality is detrimentally affected because of failed nozzles in the primary nozzle set, the redundant nozzle set can be engaged to replace the failed primary nozzle set. In another mode, the redundant nozzle set can be used to supplement the primary nozzle set, for example, to increase print speed and/or print additional colors.

Another aspect of the present invention is, therefore, a method for ink jet printing onto a substrate, comprising the steps of:

(a) providing an ink jet printer that is responsive to digital data signals, as set forth above and as discussed further below;

(b) loading the printer with a substrate to be printed;

(c) loading the printer with an inkjet ink set; and

(d) printing onto the substrate using the inkjet ink set in response to the digital data signals,

wherein the printer is operated in a first mode in which the redundant sets of nozzles (e.g., the third, fourth, sixth and eighth series of nozzles) are engaged as replacements for failed nozzles in the corresponding primary sets of nozzles (the first, second, fifth and seventh series of nozzles); and/or the printer is operated in a second mode in which he redundant sets of nozzles are used as a supplement to and in cooperation with the corresponding primary sets of nozzles.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### BRIEF DESCRIPTION OF THE DRAWINGS

FIG. 1 depicts a fixed inkjet printhead array with a first nozzle arrangement and a substrate.

FIG. 2 depicts a fixed inkjet printhead array with an alternative nozzle arrangement.

### DETAILED DESCRIPTION OF THE PREFERRED EMBODIMENTS

Fixed Array Inkjet Printhead

The ink jet printhead used in the context of the present invention is an array in fixed position (fixed array). Although the ink droplets ejected from the printhead can be of any suitable volume, preferably droplets are less than about 10 pL, more preferably less than about 5 pL, and still more preferably about 2 pL or less. Preferably the droplets are in the range of from about 1 to about 5 pL, even more preferably from about 1 to about 2 pL. The printer can be, for example, similar to that described in U.S. Pat. No. 6,443,555 (the disclosure of which is incorporated by reference herein for all purposes as if fully set forth). The printhead(s) for such a printer can be, for example, those described in U.S. Pat. No. 6,426,014 and US20020033863 (the disclosures of which are also incorporated by reference herein for all purposes as if fully set forth).

The fixed array printers will generally be capable of printing at least about 600 dpi, preferably at least about 720 dpi, and more preferably at least about 1200 dpi. Printing is preferably accomplished in one pass, and thus the printhead is configured to achieve the stipulated dpi in a single pass of the substrate through the printing zone.

The width of the printing zone is preferably at least as wide as the width of the area of the substrate to be printed so that printing can be performed rapidly in one pass. Accordingly, printheads of this sort are commonly referred to as page-wide arrays or full-width arrays. For so-called “SOHO” (small office, home office) and “network” printing, the width of the printing zone is at least wide as standard papers, such as A4 size paper and/or letter size (8.5×11 inch) paper. For so-called “wide-format” printing, the print zone is preferably at least about 36 inches wide and can accommodate media that is fed from a roll.

The “printhead” will generally be referred to in the singular no matter whether it is a monolithic structure or comprised of a plurality of segments or modules. Regardless of the arrangement, all nozzles act cooperatively to generate an image.

Traditionally, there is a single series of nozzles for each ink in the ink set, and each of these single sets of nozzles is spaced so as to provide full coverage for each ink across the print zone. According to the present invention, instead of only a single series of nozzles for a given colored ink, there is first series (primary set) of nozzles and a second corresponding series of nozzles (redundant set), preferably with substantially the same number or nozzles as the first series. The term “corresponding nozzles” refers to pairs of nozzles, one from the primary set and one from the redundant set, aligned in the substrate feed direction such that they can each print on the same part of the substrate. A redundant set of nozzles and the corresponding primary set of nozzles must both jet ink of substantially the same color. Further in accordance with the present invention, there are at least two sets of redundant nozzles, one redundant set for each of two differently colored inks.

Generally, an ink set will comprise at least the three primary colors—cyan, yellow and magenta (CYM). It can be advantageous to provide at least three sets of redundant nozzles, one redundant set for each or the primary colors. Thus there would be provided primary and redundant set of nozzles for a cyan ink, a primary and redundant set of nozzles for a yellow ink, and a primary and redundant set of nozzles for a magenta ink.

Commonly, an ink set is comprised of four differently colored inks (typically CYMK). An ink set can also be an “expanded” to include five or more colored inks, for example, CYMK plus any one or all of R (red), G (green) and/or B (blue). A printhead could comprise four or more sets of redundant nozzles, with one set for each of the colors.

In another embodiment, the printhead contains a separate redundant set of nozzles for each color of the ink set except for black and/or secondary colors (RGB). Since black and secondary colors can be printed by various combinations of the CYM inks, the redundant set of nozzles for these three inks could thus in combination be used as the redundant set of nozzles for black and/or the secondary colors.

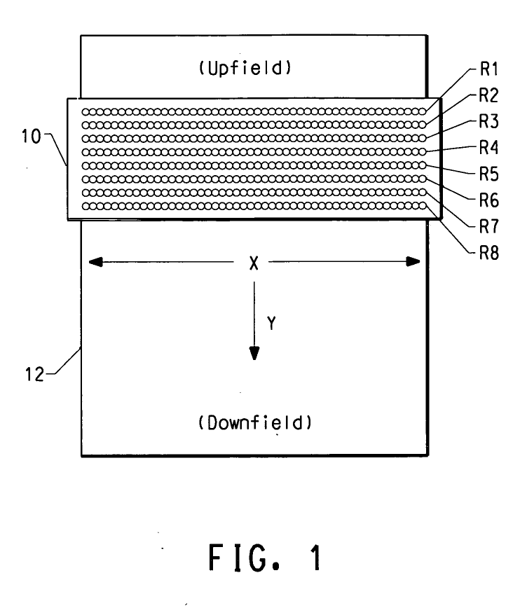

Referring to FIG. 1, there is depicted a printhead 10 which is shown spanning the width of a substrate 12 (the “X” direction). The substrate 12 moves past the printhead 10 in the “Y” direction. The Y direction after printing is referred to as “downfield” and before the printing as “upfield”. The nozzles, represented by unfilled circles, are in a series of rows R1-R8 in the printhead 10, and extend in the X direction to at least the margins of the print area. The extent of the margins is a matter of choice.

The series of nozzles in rows R1-R8 depicted in FIG. 1 can be used, for example, to jet a four-color ink set such as a cyan, yellow, magenta and black color set. Using a CYMK ink set for illustration, and not in any way limiting the invention, R1 can represent a first (primary) series of nozzles for a cyan ink and R2 can represent a second (redundant) series of cyan nozzles. Likewise R3 and R4 can be the primary and redundant series of nozzles for a yellow ink; R5 and R6 can be the primary and redundant series of nozzles for a magenta ink and R7 and R8 can be the primary and redundant series of nozzles for a black ink. Alternatively, nozzles rows R1-R4 can be the first primary set of nozzles for each of the CYMK inks and R5-R8 can be the redundant set of nozzles for each of the CYMK inks. Any other combination can be used as well.

As shown in FIG. 1, the rows of nozzles extend perpendicular to the substrate feed direction, but this need not be the case. It may be advantageous to configure the printhead at an angle from the perpendicular. Such an angled configuration can sometimes allow higher dpi. Furthermore, the nozzles need not be in a straight row but rather can be any suitable arrangement, for example, some sort of staggered arrangement. WO03/097361 illustrates several embodiments of a fixed array comprised staggered, “tiled” printheads, and U.S. Pat. No. 6,652,088 illustrates a fixed array comprised of staggered, tiled and angled printheads (the disclosures of both of the publications are incorporated by reference herein for all purposes as if fully set forth).

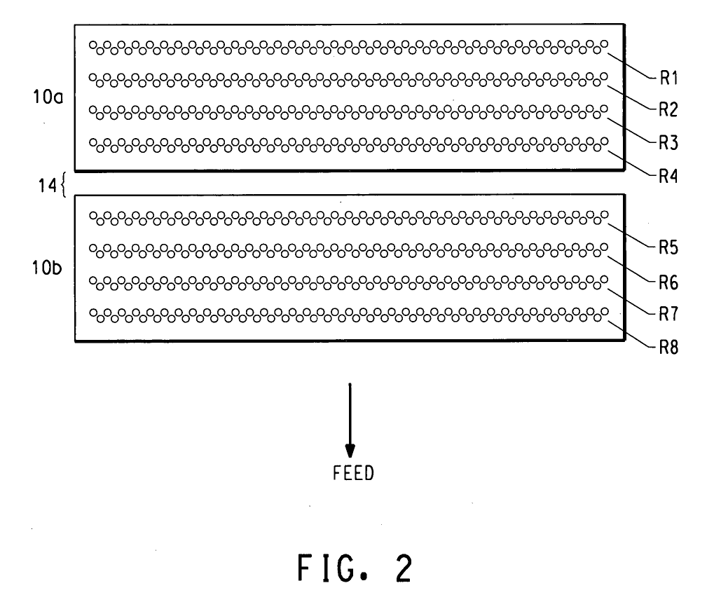

With regard to FIG. 2, there is depicted an alternative arrangement where the printhead is in two segments, 10a and 10b, separated by a gap 14. The gap 14 can be any desired width, or it can be effectively zero (segments 10a and 10b abut). The nozzles, represented by unfilled circles, in each series, R1-R8, are staggered, allowing higher density. Again using a CYMK ink set for illustration, series R1-R4 can represent the primary set of nozzles for each of the CYMK inks and series R5-R8 can represent the redundant set of nozzles for each of the CYMK inks. The colors can be in any order and the redundant set need not be in the same order as the primary set.

It can be readily appreciated that various printhead configurations can satisfy the prescribed redundant nozzle arrangement. Furthermore, the printhead can be equipped with any desired number of ink colors numbering two or more.

Ink Supply

In operation of the printer, each series of nozzles is fluid connection with an ink supply through an ink supply path. The ink supply path can be any suitable means to supply ink including, simply, tubing running from an ink tank to (a) port(s) on the printhead. Ink channels within the printhead can connect the port to the nozzles.

For a series of nozzles to be a redundant set, it must be equipped with an ink of the same color ink as the primary set. Here, the term “an ink of the same color” includes not only an ink of the exact same (identical) composition, but also an ink with the same color but different composition. Generally it is preferable for the ink in a primary and redundant nozzle set to be substantially identical inks (for example, substantially the same composition but from different manufacturing lots but within normal manufacturing allowances). However, there may be situations where it is desirable for the ink in the redundant set to be of a different formulation than the ink in the corresponding primary set.

For the purposes of this invention, ink color will be named according to hue angle ranges as follows (between about and about).

| Color | Hue Angle Range |
|---|---|
| Red | 10-70 |
| Yellow | 70-120 |
| Green | 120-180 |
| Cyan | 180-250 |
| Blue | 250-320 |
| Magenta | 320-10 |

The hue angle is determined by spectrophotometric measurement of a solution or by printing an ink onto high quality inkjet media, such as photo paper, and measuring the color with a spectrometer. In the case where hue angle differs substantially between methods, the solution measurement should be preferred.

Suitable inks for use in inkjet printers are generally well known to those of ordinary skill in the art, and numerous examples exist in the literature as well as in commerce. For example, suitable inks include those widely available for commercial desk top and large format printers from manufacturers, including Hewlett Packard, Epson and Canon among many others. Non-limiting exemplary ink formulations are also disclosed in, for example, U.S. Pat. No. 5,085,698 and WO01/94476, as well as commonly owned U.S. application Ser. No. 11/105,258 (filed Apr. 13, 2005) (claiming priority from U.S. Provisional Application Ser. No. 60/564,062 (filed Apr. 21, 2004)) and U.S. application Ser. No. 11/148,905 (filed Jun. 9, 2005) (claiming priority from U.S. Provisional Application Ser. No. 60/583,235 (filed Jun. 25, 2004)), the disclosures of which are incorporated herein by reference for all purposes as if fully set forth.

In addition to the at least two colored inks, colorless inks may be utilized as well within the concept of the present invention. For example, it is known in the inkjet art to print a fixer ink over and/or under a colored ink to enhance the coloristic and/or durability properties of the printed image. Typically, a fixer for dye inks is designed to increase water fastness, and a fixer for pigment inks is designed to increase chroma and/or optical density. However, fixer inks may also have other and/or additional beneficial effects, as is well known to those of ordinary skill in the relevant art. Fixer inks are generally also substantially colorless and do not perceptibly or substantially change the hue of a colored ink fixed by the fixer fluid. Thus, a colorless ink can be associated with a primary and a redundant series of nozzles as well.

The choice of inks and ink sets actually used in the present invention will depend on a number of factors generally recognized by those of ordinary skill in the art, such as substrate type, printhead type and actuator, printing conditions and ultimate end use of the substrate.

Means for Moving Substrate

The means for moving the substrate to be printed past the print zone can be any known means, and an equivalent thereto. Substrate handling means in printers, including printers other than inkjet printers, are generally well known to those of ordinary skill in the art, and numerous examples exist in the literature as well as in commerce.

As the present invention pertains to a page-wide array that preferably accomplishes all printing in one pass, preferably the substrate handling means, and any associated electronic controls, are designed to move the substrate past the print zone once (and only once).

Substrates

Substrates suitable for use in the present invention can be any useful substrate known to those of ordinary skill in the relevant art. For example, the substrate can be plain paper such as common electrophotographic copier paper. The substrate can also be specialty media such as microporous papers, polymer coated papers and hybids of the two. The substrate can be polymeric film such as vinyl chloride and polyester. Polymeric films are especially useful in wide-format applications such as signs, billboards and banners. The substrate can be a non-woven textile such as spun bonded polyolefin (e.g. Tyvek®, DuPont Co.). The substrate can also be woven textile such as silk, cotton, nylon and polyester.

The substrate can be in page or sheet form, or in the form or in the form or a continuous web fed from a roll.

Mode of Operation

The redundant set of nozzles can be employed in various ways.

For example, in one preferred mode of operation (first mode), the redundant nozzles are used as a reserve set and engaged substantially only as a replacement for a failed primary nozzle. Suitable methods for detecting failed nozzles (nozzle outs) are generally well known to those of ordinary skill in the art, and numerous examples exist in the literature as well as in commerce. In another preferred mode of operation (second mode), the redundant nozzles are used as a supplement to and in cooperation with the operative primary set nozzles. Of course, various combinations of these modes can be utilized as well.

Although the present invention prescribes at least two sets of redundant nozzles for each of two different inks, it is not necessary that all inks in an ink set have a redundant nozzle set. It may be desirable and within the definition of this invention to have redundant nozzles sets only for the primary colors (CYM) and not for black or any secondary color (R, G and/or B) colors. This arrangement could be suitable because a failed K, R, G or B nozzle could be filled with a combination of CYM, but there is no back up for the primary colors. Alternatively, including a redundant set of K nozzles as well as CYM, could allow faster printing when operating in either of the modes described above.

1. An inkjet printing apparatus comprising:
(a) a plurality of ink supply paths, comprising a first ink supply path for connection to a first ink supply to contain a first ink of a first color, a second ink supply path for connection to a second ink supply to contain a second ink of a second color, a third ink supply path for connection to a third ink supply to contain a third ink of substantially the same color as said first color, and a fourth ink supply path for connection to a fourth ink supply to contain a fourth ink of substantially the same color as said second color, wherein said first and second colors are not substantially the same;
(b) an inkjet printhead array in fixed position, responsive to digital data signals and in connection with said plurality of ink supply paths such that, when an ink supply containing an ink is connected to an ink supply path, said ink can flow from said ink supply to said inkjet printhead array;
(c) a printing zone defined by said inkjet printhead array; and
(d) a means for moving a substrate to be printed past said printing zone;
wherein said inkjet printhead array comprises a plurality of series of nozzles, each of said series of nozzles being arranged in a direction generally across said printing zone, said plurality of series of nozzles comprising:
a first series of nozzles being in connection with said first ink supply path such that, when a first ink supply is connected to said first ink supply path, a first ink can flow from said first ink supply to said first series of nozzles;
a second series of nozzles being in connection with said second ink supply path such that, when a second ink supply is connected to said second ink supply path, a second ink can flow from said second ink supply to said second series of nozzles;
a third series of nozzles being in connection with said third ink supply path such that, when a third ink supply is connected to said third ink supply path, a third ink can flow from said third ink supply to said third series of nozzles; and
a fourth series of nozzles being in connection with said fourth ink supply path such that, when a fourth ink supply is connected to said fourth ink supply path, a fourth ink can flow from said fourth ink supply to said fourth series of nozzles;
said third series of nozzles being redundant to said corresponding first series of nozzles, and said fourth series of nozzles being redundant to said corresponding second series of nozzles.

2. The inkjet printing apparatus of claim 1, wherein the plurality of ink supply paths further comprises:
a fifth ink supply path for connection to a fifth ink supply to contain a fifth ink of said third color; and
a sixth ink supply path for connection to a sixth ink supply to contain a sixth ink of substantially the same color as said third color;
wherein said first, second and third colors are not substantially the same; and
wherein said plurality of series of nozzles further comprises:
a fifth series of nozzles being in connection with said fifth ink supply path such that, when a fifth ink supply is connected to said fifth ink supply path, a fifth ink can flow from said fifth ink supply to said fifth series of nozzles; and
a sixth series of nozzles being in connection with said sixth ink supply path such that, when a sixth ink supply is connected to said sixth ink supply path, said sixth ink can flow from said sixth ink supply to said sixth series of nozzles;
with said sixth series of nozzles being redundant to said corresponding fifth series of nozzles.

3. The inkjet printing apparatus of claim 2, wherein the plurality of ink supply paths further comprises:
a seventh ink supply path for connection to a seventh ink supply to contain a seventh ink of said fourth color; and
optionally, an eighth ink supply path for connection to an eighth ink supply to contain an eighth ink of substantially the same color as said seventh color;
wherein said first, second, third and fourth colors are not substantially the same; and
wherein said plurality of series of nozzles further comprises:
a seventh series of nozzles being in connection with said seventh ink supply path such that, when a seventh ink supply is connected to said seventh ink supply path, a seventh ink can flow from said seventh ink supply to said seventh series of nozzles; and
optionally, an eighth series of nozzles being in connection with said eighth ink supply path such that, when an eighth ink supply is connected to said eighth ink supply path, an eighth ink can flow from said eighth ink supply to said eighth series of nozzles;
with said eighth series of nozzles, when present, being redundant to said corresponding seventh series of nozzles.

4. The inkjet printing apparatus of claim 1, further comprising:
(e) a first ink supply containing a first ink of a first color connected to said first ink supply path, such that said first ink can flow from said first ink supply to said first series of nozzles;
(f) a second ink supply containing a second ink of a second color connected to said second ink supply path, such that said second ink can flow from said second ink supply to said second series of nozzles;
(g) a third ink supply containing a third ink of substantially the same color as said first color connected to said third ink supply path, such that said third ink can flow from said third ink supply to said third series of nozzles; and
(h) a fourth ink supply containing a fourth ink of substantially the same color as said second color connected to said fourth ink supply path, such that said fourth ink can flow from said fourth ink supply to said fourth series of nozzles;
wherein said first and second colors are not substantially the same.

5. The inkjet printing apparatus of claim 4, wherein the plurality of ink supply paths further comprises:
a fifth ink supply path for connection to a fifth ink supply to contain a fifth ink of said third color; and
a sixth ink supply path for connection to a sixth ink supply to contain a sixth ink of substantially the same color as said third color;
wherein said plurality of series of nozzles further comprises:
a fifth series of nozzles being in connection with said fifth ink supply path such that, when a fifth ink supply is connected to said fifth ink supply path, a fifth ink can flow from said fifth ink supply to said fifth series of nozzles;
a sixth series of nozzles being in connection with said sixth ink supply path such that, when a sixth ink supply is connected to said sixth ink supply path, said sixth ink can flow from said sixth ink supply to said sixth series of nozzles;
with said sixth series of nozzles being redundant to said corresponding fifth series of nozzles;
wherein the inkjet printing apparatus further comprises:
(i) a fifth ink supply containing a fifth ink of a third color connected to said fifth ink supply path, such that said fifth ink can flow from said fifth ink supply to said fifth series of nozzles; and
(j) a sixth ink supply containing a sixth ink of substantially the same color as said third color connected to said sixth ink supply path, such that said sixth ink can flow from said sixth ink supply to said sixth series of nozzles;
and wherein said first, second and third colors are not substantially the same.

6. The inkjet printing apparatus of claim 5, wherein the plurality of ink supply paths further comprises:
a seventh ink supply path for connection to a seventh ink supply to contain a seventh ink of said fourth color; and
optionally, an eighth ink supply path for connection to an eighth ink supply to contain an eighth ink of substantially the same color as said seventh color;
wherein said plurality of series of nozzles further comprises:
a seventh series of nozzles being in connection with said seventh ink supply path such that, when a seventh ink supply is connected to said seventh ink supply path, a seventh ink can flow from said seventh ink supply to said seventh series of nozzles;
optionally, an eighth series of nozzles being in connection with said eighth ink supply path such that, when an eighth ink supply is connected to said eighth ink supply path, an eighth ink can flow from said eighth ink supply to said eighth series of nozzles;
with said eighth series of nozzles, when present, being redundant to said corresponding seventh series of nozzles;
wherein the inkjet printing apparatus further comprises:
(k) a seventh ink supply containing a seventh ink of a fourth color connected to said seventh ink supply path, such that said seventh ink can flow from said seventh ink supply to said seventh series of nozzles, and
(l) optionally, an eighth ink supply containing an eighth ink of substantially the same color as said fourth color connected to said eighth ink supply path, such that said eighth ink can flow from said eighth ink supply to said eighth series of nozzles;
and wherein said first, second, third and fourth colors are not substantially the same.

7. The inkjet printing apparatus of claim 2, wherein said first color is cyan, said second color is magenta and said third color is yellow.

8. The inkjet printing apparatus of claim 5, wherein said first color is cyan, said second color is magenta and said third color is yellow.

9. The inkjet printing apparatus of claim 3, wherein said first color is cyan, said second color is magenta, said third color is yellow and said fourth color is black.

10. The inkjet printing apparatus of claim 6, wherein said first color is cyan, said second color is magenta, said third color is yellow and said fourth color is black.

11. The inkjet printing apparatus of claim 1, wherein the print density is 720 dpi or greater.

12. A method for ink jet printing onto a substrate, comprising the steps of:
(a) providing an ink jet printing apparatus that is responsive to digital data signals;
(b) loading the inkjet printing apparatus with a substrate to be printed;
(c) loading the inkjet printing apparatus with an inkjet ink set; and
(d) printing onto the substrate using the inkjet ink set in response to the digital data signals,
wherein the inkjet printing apparatus comprises:
(a1) a plurality of ink supply paths, comprising a first ink supply path for connection to a first ink supply to contain a first ink of a first color, a second ink supply path for connection to a second ink supply to contain a second ink of a second color, a third ink supply path for connection to a third ink supply to contain a third ink of substantially the same color as said first color, and a fourth ink supply path for connection to a fourth ink supply to contain a fourth ink of substantially the same color as said second color;
(a2) an inkjet printhead array in fixed position, responsive to digital data signals and in connection with said plurality of ink supply paths such that, when an ink supply containing an ink is connected to an ink supply path, said ink can flow from said ink supply to said inkjet printhead array;
(a3) a printing zone defined by said inkjet printhead array; and
(a4) a means for moving a substrate to be printed past said printing zone;
wherein said inkjet printhead array comprises a plurality of series of nozzles, each of said series of nozzles being arranged in a direction generally across said printing zone, said plurality of series of nozzles comprising:
a first series of nozzles being in connection with said first ink supply path such that, when a first ink supply is connected to said first ink supply path, a first ink can flow from said first ink supply to said first series of nozzles;
a second series of nozzles being in connection with said second ink supply path such that, when a second ink supply is connected to said second ink supply path, a second ink can flow from said second ink supply to said second series of nozzles;
a third series of nozzles being in connection with said third ink supply path such that, when a third ink supply is connected to said third ink supply path, a third ink can flow from said third ink supply to said third series of nozzles; and
a fourth series of nozzles being in connection with said fourth ink supply path such that, when a fourth ink supply is connected to said fourth ink supply path, a fourth ink can flow from said fourth ink supply to said fourth series of nozzles;
said third series of nozzles being redundant to said corresponding first series of nozzles, and said fourth series of nozzles being redundant to said corresponding second series of nozzles;
(a5) a first ink supply containing a first ink of a first color connected to said first ink supply path, such that said first ink can flow from said first ink supply to said first series of nozzles;
(a6) a second ink supply containing a second ink of a second color connected to said second ink supply path, such that said second ink can flow from said second ink supply to said second series of nozzles;
(a7) a third ink supply containing a third ink of substantially the same color as said first color connected to said third ink supply path, such that said third ink can flow from said third ink supply to said third series of nozzles; and
(a8) a fourth ink supply containing a fourth ink of substantially the same color as said second color connected to said fourth ink supply path, such that said fourth ink can flow from said fourth ink supply to said fourth series of nozzles;
wherein said first and second colors are not substantially the same;
and wherein the inkjet printing apparatus is operated in a first mode in which the redundant series of nozzles are engaged as replacements for the corresponding series of nozzles that have failed; and/or the inkjet printing apparatus is operated in a second mode in which the redundant series of nozzles are used as a supplement to and in cooperation with the corresponding series of nozzles.

13. The method of claim 12, wherein said plurality of ink supply paths further comprises:
a fifth ink supply path for connection to a fifth ink supply to contain a fifth ink of said third color; and
a sixth ink supply path for connection to a sixth ink supply to contain a sixth ink of substantially the same color as said third color;
wherein said plurality of series of nozzles further comprises:
a fifth series of nozzles being in connection with said fifth ink supply path such that, when a fifth ink supply is connected to said fifth ink supply path, a fifth ink can flow from said fifth ink supply to said fifth series of nozzles;
a sixth series of nozzles being in connection with said sixth ink supply path such that, when a sixth ink supply is connected to said sixth ink supply path, said sixth ink can flow from said sixth ink supply to said sixth series of nozzles;
with said sixth series of nozzles being redundant to said corresponding fifth series of nozzles;
wherein the inkjet printing apparatus further comprises:
(a9) a fifth ink supply containing a fifth ink of a third color connected to said fifth ink supply path, such that said fifth ink can flow from said fifth ink supply to said fifth series of nozzles; and
(a10) a sixth ink supply containing a sixth ink of substantially the same color as said third color connected to said sixth ink supply path, such that said sixth ink can flow from said sixth ink supply to said sixth series of nozzles;
and wherein said first, second and third colors are not substantially the same.

14. The method of claim 13, wherein said plurality of ink supply paths further comprises:
a seventh ink supply path for connection to a seventh ink supply to contain a seventh ink of said fourth color; and
optionally, an eighth ink supply path for connection to an eighth ink supply to contain an eighth ink of substantially the same color as said seventh color;
wherein said plurality of series of nozzles further comprises:
a seventh series of nozzles being in connection with said seventh ink supply path such that, when a seventh ink supply is connected to said seventh ink supply path, a seventh ink can flow from said seventh ink supply to said seventh series of nozzles;
optionally, an eighth series of nozzles being in connection with said eighth ink supply path such that, when an eighth ink supply is connected to said eighth ink supply path, an eighth ink can flow from said eighth ink supply to said eighth series of nozzles;
with said eighth series of nozzles, when present, being redundant to said corresponding seventh series of nozzles;
wherein the inkjet printing apparatus further comprises:
(k) a seventh ink supply containing a seventh ink of a fourth color connected to said seventh ink supply path, such that said seventh ink can flow from said seventh ink supply to said seventh series of nozzles; and
(l) optionally, an eighth ink supply containing an eighth ink of substantially the same color as said fourth color connected to said eighth ink supply path, such that said eighth ink can flow from said eighth ink supply to said eighth series of nozzles;
and wherein said first, second, third and fourth colors are not substantially the same.

15. The method of claim 13, wherein said first color is cyan, said second color is magenta and said third color is yellow.

16. The method of claim 14, wherein said first color is cyan, said second color is magenta, said third color is yellow and said fourth color is black.

17. The method of claim 12, wherein the print density is 720 dpi or greater.
